(19) United States
(12) Patent Application Publication
(10) Pub. No.: US 2018/0256296 A1
(43) Pub. Date: Sep. 13, 2018

(54) ORTHODONTIC APPLIANCE

(71) Applicant: ARCHFORM BYTE LIMITED, SHEFFIELD S9 1DH - SOUTH YORKSHIRE (GB)

(72) Inventor: ROBERT CLIVE HUDSON, SHEFFIELD S9 1DH - SOUTH YORKSHIRE (GB)

(21) Appl. No.: 15/914,688

(22) Filed: Mar. 7, 2018

(30) Foreign Application Priority Data
Mar. 7, 2017 (GB) 1703622.9

(51) Int. Cl. A61C 7/08; A61C 7/36

(52) U.S. Cl. CPC A61C 7/08; A61C 7/36

(57) ABSTRACT

An orthodontic appliance is described which comprises an upper element 10 and a lower element 12, wherein at least one of the upper and lower elements 10, 12 takes the form of an active appliance, and wherein each of the upper and lower elements 10, 12 includes, on or associated with a surface thereof facing towards the other of the upper and lower elements 10, 12, an engagement member 18, the engagement members 18 being positioned such that, in use, the engagement member 18 associated with the lower element 12 is engageable with the engagement member 18 associated with the upper element 10 to urge the lower element 12 towards a desired position relative to the upper element 10.

This invention relates to an orthodontic appliance.

Active orthodontic appliances are in widespread use to adjust the positions and orientations of a patient's teeth to develop the patient's upper and/or lower arches in a desired manner. Appliances used for this purpose take a range of forms, either being fixed in position by an orthodontist, or being of removable form, including features which cooperate with individual ones of the patient's teeth to urge the teeth towards a desired position and/or orientation. Over time, as the appliance achieves the effect of repositioning and/or reorienting the teeth, the appliance may require adjustment or replacement in order to continue to achieve the desired result.

Another form of orthodontic appliance in widespread use is a functional appliance which serves to modify the rest position of the patient's mandible relative to his maxilla. One form of functional appliance in common use is a twin block appliance. In such an appliance, an upper block of the appliance is fitted, in use, to the patient's upper teeth, and a lower block is fitted to the patient's lower teeth. In use, the blocks cooperate with one another in such a manner that the mandible is urged towards a desired position relative to the maxilla.

It is common for patient's to require treatment using both forms of appliance, for example using a functional appliance in order to correct or modify mandibular position and subsequently using an active appliance to modify tooth position. The need to use two different forms of treatment in sequence can result in some patients being under treatment for a considerable period of time.

It is an object of the invention to provide an orthodontic appliance in which at least some of the disadvantages associated with known orthodontic appliances are overcome or are of reduced effect.

According to an aspect of the invention there is provided an orthodontic appliance comprising an element in the form of an active appliance, and wherein the element includes an engagement member, the engagement members being positioned such that, in use, the engagement member is engageable with an occlusal surface of an opposing element, an engagement member associated therewith or an occlusal surface of a tooth to urge the element towards a desired position.

It will be appreciated that the appliance serves both as an active appliance and as a functional appliance.

It is envisaged that often a pair of appliances will be used. Accordingly, according to another aspect of the invention there is provided an orthodontic appliance comprising an upper element and a lower element, wherein at least one of the upper and lower elements takes the form of an active appliance, and wherein each of the upper and lower elements includes, in a location facing towards the other of the upper and lower elements, an engagement member, the engagement members being positioned such that, in use, the engagement member associated with the lower element is engageable with the engagement member associated with the upper element to urge the lower element towards a desired position relative to the upper element.

Such an appliance is advantageous in that in addition to serving as an active appliance, achieving adjustment of the position and/or orientation of individual ones of the patient's teeth, it also serves as a functional appliance. By using an appliance of this form in the treatment of a patient, the treatment time may be shortened through both types of treatment being undertaken simultaneously rather than undertaking the two types of treatment in sequence.

The engagement members are preferably of inclined or ramped form. In such an arrangement, as the mandible is moved towards a closed position relative to the maxilla, the interengagement or cooperation between the inclined engagement members can drive the mandible towards an extended to retracted position, as desired, relative to the maxilla. The slope of the inclined engagement members may be selected to depending upon the manner in which the patient is to be treated.

Preferably, the upper element is provided with two engagement members, laterally spaced from one another. Similarly, the lower element is preferably provided with two engagement members, each of the engagement members of the lower element being cooperable, in use, with a respective one of the engagement members of the upper element. Again, the engagement members may be of ramped or inclined form, and the slopes thereof may be chosen to suit the manner in which the patient is to be treated.

The upper and lower elements conveniently each take the form of an arcuate member of generally channel shaped form, the member being shaped to define individual pockets or regions such that, when fitted, individual ones of a patient's teeth are received within respective ones of the individual pockets or regions, at least some of the pockets or regions being shaped and/or positioned in so as to urge, in use, the associated ones of the patient's teeth towards desired positions and/orientations.

The upper and lower elements are conveniently of a plastics material, for example vacuum formed over a model of the patient's teeth, manipulated to achieve a desired effect. The plastics material is preferably of transparent form. Such an arrangement is advantageous in that it is of relatively unobtrusive form. The appliance is relatively simply to fit and remove, and so may be suitable for temporary removal by the patient, for example for hygiene reasons, and subsequent refitting.

Where the upper and lower elements are of the form set out hereinbefore, the engagement members are conveniently integrally moulded or formed into the upper and lower elements. They may be positioned, for example, to overlie certain of the patient's molars or canines, in use. The exact positions of the engagement members may be selected to suit the manner in which the patient is being treated and/or to reduce discomfort to the patient.

As is common where a patient is being treated using active appliances, the patient will typically require several different active appliances during the course of treatment, the locations and/or shapes of the pockets or regions thereof differing to result the teeth being moved, over the course of the treatment, towards a desired position and/or orientation. Where a series of appliances are used in a course of treatment, the positions, shapes, etc of the engagement members may also be modified as the treatment progresses, if desired.

The invention will further be described, by way of example, with reference to the accompanying drawings, in which:

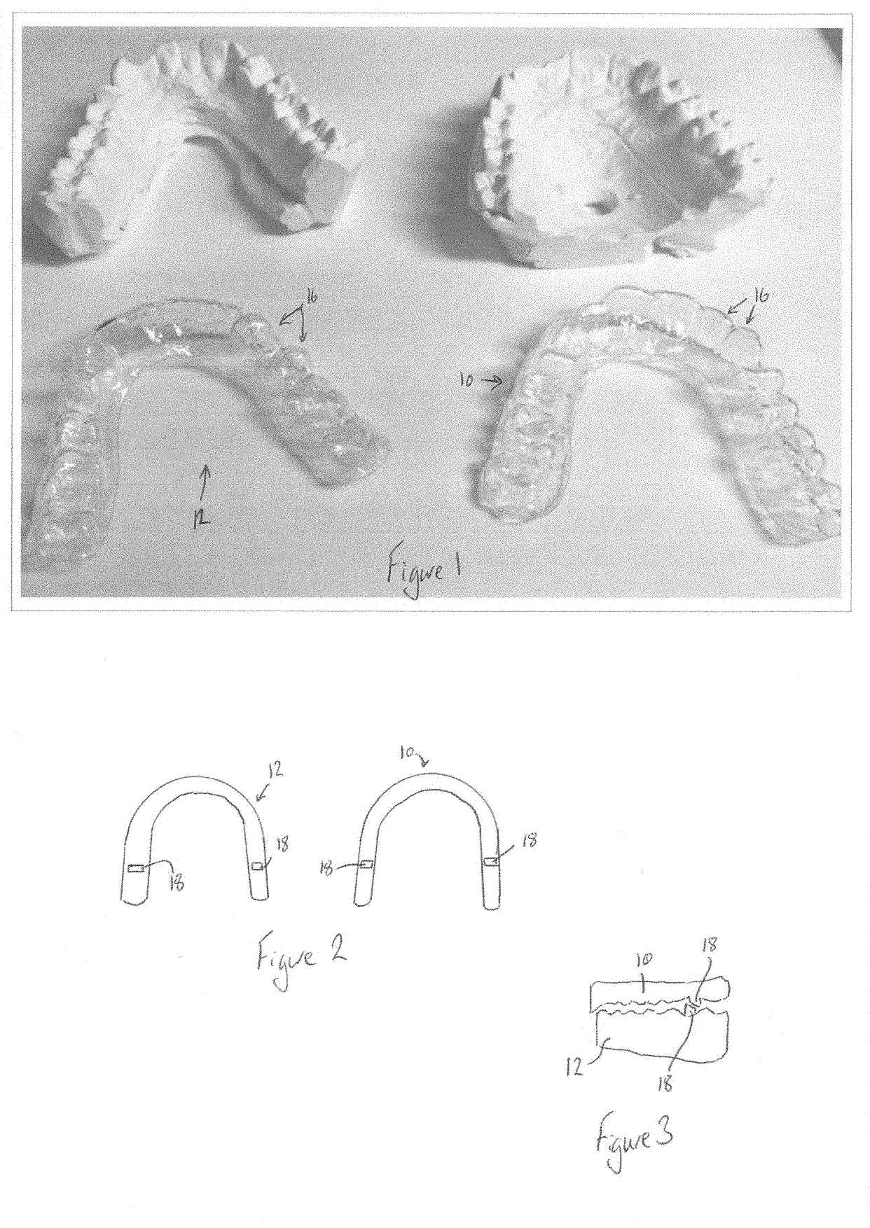

FIG. 1 is a photograph of the upper and lower elements of a known form of active appliance;

FIG. 2 is a diagrammatic plan view of the upper and lower elements of an orthodontic appliance in accordance with an embodiment of the invention; and

FIG. 3 is a diagrammatic side view illustrating the elements of the orthodontic appliance of FIG. 2.

Referring firstly to FIG. 1, a known form of active orthodontic appliance is shown. The appliance comprises an upper element 10 intended to be fitted, in use, over the upper teeth, and a lower element 12 intended to be fitted, in use, over the patient's lower teeth. Each of the elements 10, 12 is of a vacuum formed plastics material, formed over a model of the patient's teeth, the model having been modified to take into account the manner in which the patient is to be treated, for example by modifying the positions and/or orientations of at least some of the teeth on the model. Each element 10, 12 is thus of arcuate form, matching the patient's upper and lower arches, and is of channel shaped cross-sectional form, defining a series of pockets or regions 16 in which individual ones of the patient's teeth are received, in use. The elements are moulded from a material of substantially uniform thickness, and so the exposed surfaces of the elements 10, 12 have a shape similar to the profile of the patient's teeth. The elements 10, 12 are conveniently of a transparent plastics material so that the appliance is relatively unobtrusive. However, this need not always be the case and translucent or opaque materials may be used, if desired.

Typically, the model of the patient's teeth is formed either by taking a mould of the patient's teeth, or by take a digital scan of the teeth. As mentioned above, the model is manipulated prior to vacuum forming of the plastics material thereon. After completion of the moulding process, a series of finishing operations are conducted, for example to remove excess material, before the appliance is ready for use.

Whilst vacuum forming over a mould represents one manner in which the elements may be manufactured, they could also be manufactured using other techniques, for example by 3D printing or the like.

Appliances of this general type are well known and so their form and operation will not be described herein in further detail.

In accordance with the invention, as shown in FIGS. 2 and 3, an appliance of the general type outlined hereinbefore is modified such that the elements 10, 12 of the appliance each include an engagement member 18. In the arrangement shown, each element 10, 12 includes a pair of engagement members 18, but there may be situations in which more or fewer engagement members are provided. Each engagement member 18 is positioned on an occlusal surface of the associated element 10, 12 which, in use, faces towards the opposing occlusal other of the elements 10, 12. Each engagement member 18 is of ramped or inclined form and is positioned such that, in use, each engagement member 18 associated with the lower element 12 abuts, engages or cooperates with a respective one of the engagements members 18 associated with the upper element 10, when fitted and when the patient moves his mandible towards a closed position relative to his maxilla. The engagement between the inclined or ramped surfaces of the engagement members 18 serves to drive the mandible towards a desired position relative to the maxilla, and so results in the appliance not only serving as an active appliance in the manner of the appliance of FIG. 1 but further results in the appliance serving as a functional appliance. Accordingly, the patient can receive both forms of treatment simultaneously rather than sequentially, and so overall treatment times may be reduced.

In the arrangement shown, the orientation of the ramps of the engagement members 18 are such that closing movement of the mandible drives the mandible forward relative to the maxilla. The inclines or slopes of the ramps may be chosen to suit the nature of the treatment to be received by the patient, controlling the degree and rate of forward movement of the mandible. Depending upon the nature of the treatment, the inclines of the engagement members provided on the left side of the appliance may match the inclines of those on the right side, such that the mandible is driven forward uniformly. However, there may be situations in which the treatment to be received by the patient requires other movements to occur, and the inclines of the engagement members may be modified to suit, if desired. By way of example, rearward movement or angular movement of the mandible may be achieved where desired.

The elements 10, 12 of the appliance may be manufactured in substantially the manner set out hereinbefore, modifying the model prior to vacuum forming of the elements 10, 12 to include features representative of the engagement members so that, in the resulting vacuum formed elements 10, 12, the engagement members 18 are integrally formed in the desired locations and are of the desired shapes. Alternatively, as mentioned hereinbefore, 3D printing or other manufacturing techniques may be employed.

It will be appreciated that the locations of the engagement members 18 may be selected depending upon the nature of the treatment. By way of example, if the active treatment of the patient involves adjustment or realignment of certain of the patient's molars or canines, then it may be desired to locate the engagement member 18 away from those ones of the molars or canines so as not to interfere with the active treatment. In view of the manner in which the appliance is manufactured, it will be appreciated that adjustment of the locations of the engagement members 18 is relatively straightforward through adjustment of the manner in which the model is manipulated prior to the formation of the elements 10, 12.

In the arrangement described hereinbefore, the upper and lower elements 10, 12 are both active appliances, both being used to achieve modification of the positions and/or orientations of the patient's teeth. It will be appreciated that this need not always be the case and that, depending upon the nature of the required treatment, only one or other of the elements 10, 12 may serve this function. However, in order to provide the effect of a functional appliance, both elements 10, 12 are required so as to provide a location and support for each of the engagement members 18.

Although the description hereinbefore is of an arrangement in which the appliance comprises two elements, arrangements are also possible in which a single element is provided, the element being provided with an engagement member which interacts with the opposing occlusal surface of the of the patient's teeth, in use, to achieve the effect described hereinbefore. Obviously, in such an arrangement, active treatment of only one of the patient's arches is achieved as no element is provided to achieve treatment of the other of the arches.

Whilst the invention is described hereinbefore in relation to a specific form of active appliance, it will be appreciated that the invention may be applied to other forms of active appliance.

Although the description hereinbefore relates to a specific embodiment of the invention, described with reference to the accompanying drawings, it will be appreciated that a wide range of modifications and alterations may be made thereto without departing from the scope of the invention as defined by the appended claims.

1. An orthodontic appliance comprising an upper element and a lower element, wherein at least one of the upper and lower elements takes the form of an active appliance, and wherein each of the upper and lower elements includes, on or associated with a surface thereof facing towards the other of the upper and lower elements, an engagement member, the engagement members being positioned such that, in use, the engagement member associated with the lower element is engageable with the engagement member associated with the upper element to urge the lower element towards a desired position relative to the upper element.

2. An appliance according to claim 1, wherein the engagement members are of inclined or ramped form.

3. An appliance according to claim 2, wherein the slopes of the inclined engagement members are selected accordingly to the manner in which the patient is to be treated.

4. An appliance according to claim 1, wherein the upper element is provided with two engagement members, laterally spaced from one another.

5. An appliance according to claim 4, wherein the lower element is provided with two engagement members, each of the engagement members of the lower element being cooperable, in use, with a respective one of the engagement members of the upper element.

6. An appliance according to claim 1, wherein the upper and lower elements each take the form of an arcuate member of generally channel shaped form, the member being shaped to define individual pockets or regions such that, when fitted, individual ones of a patient's teeth are received within respective ones of the individual pockets or regions.

7. An appliance according to claim 6, wherein at least some of the pockets or regions of at least one of the upper and lower elements are shaped and/or positioned in so as to urge, in use, the associated ones of the patient's teeth towards desired positions and/orientations.

8. An appliance according to claim 6, wherein the upper and lower elements are of a plastics material.

9. An appliance according to claim 8, wherein the plastics material is a transparent plastics material.

10. An appliance according to claim 8, wherein the plastics material is vacuum formed over a model of the patient's teeth, the model having been manipulated to achieve a desired effect.

11. An appliance according to claim 10, wherein the model has been manipulated to result in the formation of the engagement members in the elements.

12. An appliance according to claim 6, wherein the engagement members are formed integrally with the upper and lower elements.

13. An orthodontic appliance comprising an element in the form of an active appliance, and wherein the element includes an engagement member, the engagement member being positioned such that, in use, the engagement member is engageable with an occlusal surface of an opposing element, an engagement member associated therewith or an occlusal surface of a tooth to urge the element towards a desired position.

14. A method of manufacture of an appliance comprising an upper element and a lower element, wherein at least one of the upper and lower elements takes the form of an active appliance, and wherein each of the upper and lower elements includes, on or associated with a surface thereof facing towards the other of the upper and lower elements, an engagement member, the engagement members being positioned such that, in use, the engagement member associated with the lower element is engageable with the engagement member associated with the upper element to urge the lower element towards a desired position relative to the upper element, the method comprising producing a modified model of a patient's teeth and vacuum forming upper and lower elements using the model, the model having been modified prior to the vacuum forming to include features which result in the formation of the engagement members in the upper and lower elements.

15. A method of manufacture of an appliance comprising an upper element and a lower element, wherein at least one of the upper and lower elements takes the form of an active appliance, and wherein each of the upper and lower elements includes, on or associated with a surface thereof facing towards the other of the upper and lower elements, an engagement member, the engagement members being positioned such that, in use, the engagement member associated with the lower element is engageable with the engagement member associated with the upper element to urge the lower element towards a desired position relative to the upper element, the method comprising producing a computer model of a patient's teeth and 3D printing the upper and lower elements using the model, the model having been modified prior to the printing to include features which result in the formation of the engagement members in the upper and lower elements.
